(19) United States
(12) Patent Application Publication
(10) Pub. No.: US 2015/0154165 A1
(43) Pub. Date: Jun. 4, 2015

(54) USER INTERFACE FOR PRESENTING AN E-BOOK ALONG WITH PUBLIC ANNOTATIONS

(71) Applicant: KOBO INCORPORATED, TORONTO (CA)

(72) Inventor: Anthony O'DONOGHUE, Toronto (CA)

(73) Assignee: KOBO INCORPORATED, TORONTO (CA)

(21) Appl. No.: 14/093,288

(22) Filed: Nov. 29, 2013

(51) Int. Cl. G06F 17/24; G06F 3/0483

(52) U.S. Cl. CPC G06F 17/241; G06F 3/0483

(57) ABSTRACT

A system and method for facilitating creation of and access to public annotations of electronic publications. A graphical user interface (GUI) is configured to display content of the electronic publication as well as annotations pertaining to the content of the electronic publication. Available annotations of the electronic publication may be downloaded to an electronic reading device through network from a remote server. The remote server may send notifications upon new annotations are available for a book. The GUI may also be configured to receive an annotation entry input by a user through the electronic reading device.

### TECHNICAL FIELD

The present disclosure relates generally to the field of electronic books, and, more specifically, to user interfaces for an electronic book.

### BACKGROUND

The use of electronic devices to read books, newspapers and magazines has become increasingly commonplace due to the numerous significant advantages afforded by such devices over conventional paper print. For example, comparing to paper print, an electronic reading device can hold much a greater amount of information, allow immediate access to new books, personalize the reading display format, and facilitate night reading, etc. Electronic reading devices can be implemented as dedicated reading devices, e.g., e-readers, as well as general-purpose electronic devices such as desktop, laptop and hand-held computers.

Author's annotations to electronic publications, whether created before or after the book is published, can expand the reading experience of a reader by providing additional information about the author and/or the book, e.g., characters, plot-lines, unique insight, fun facts, explanations, and so on. However, publications, including electronically published materials, are usually released without authors' annotations, especially those annotations pertaining to specific content of the book.

In addition, readers of a book or an article are often inclined to share reviews and comments of the books with each other. Conventionally, readers have to submit their on-line comments through a forum that is independent of the reading application program installed on the electronic reading device, such as an on-line book reading club or a fan page of an on-line social network. It would be advantageous to expand the distribution mechanism for annotations related to e-books and other electronic content.

### SUMMARY OF THE INVENTION

Therefore, it would be advantageous to provide a mechanism of facilitating creation of and access to annotations of electronic publications, e.g., e-books. Accordingly, embodiments of the present disclosure employ a computer implemented method of presenting a graphical user interface (GUI) configured to display content of the electronic publication as well as annotations pertaining to the content of the electronic publication. Available annotations of the electronic publication may be downloaded to an electronic reading device through network from a remote server. The remote server may send notifications upon new annotations are available for a book Annotations may originate from the author or from the public in general, including book readers.

The GUI may also be configured to receive an annotation entry, input by a user through the electronic reading device. An initial annotation may be followed by a series of response annotations from the reader community, which may be arranged on-screen as a running commentary or dialog in the GUI. The GUI may include different annotation icons placed adjacent to the pertinent content and respectively representing presence of an author's annotation and other annotations. The capability to control postings for the display of a running dialog may reside with the respective annotators. Therefore, a book reader can conveniently view up-to-date public annotations of the e-book as well as share his or her annotations with the reader community using the same book reading program installed on the reader device.

In one embodiment of the present disclosure, a computer implemented method of displaying information related to published electronic book thereof on a display device comprises: (1) accessing content of the published electronic book; (2) rendering a first graphical user interface (GUI) on the display device, wherein the first GUI is configured to display the content of the published electronic book; (3) accessing a public annotation, and wherein the public annotation is published after publication of the published electronic book, and (4) displaying the public annotation in the first GUI. The method may further comprise receiving a notification through a communication network indicating availability of public annotations of the published electronic book, wherein the first GUI is further configured to: present an on-screen indicia indicative of the notification; and receive a user request for displaying the public annotation on the display device.

The method may further comprise accessing a number of response annotations through the communication network responsive to a user interaction with the first GUI, wherein the first GUI is further configured to display the number of response annotations and the public annotation in a format resembling a conversation thread, in response to a user request. The public annotation may be authored by an authorized annotator selected from a group consisting of an author of the electronic book, an editor of the electronic book, and a publisher-invited annotator of the electronic book, and the response annotations are authored by users having access to the electronic book. The first GUI may be further configured to render a first visual object proximate to the selected portion, wherein the first visual object is representative of the author's identification; and render a second visual object proximate to the selected portion, wherein the second visual object is representative of public annotators generically. The first GUI may be further configured to receive an annotation entry pertaining to the content through the display device, and further comprising submitting the annotation entry to the remote server through the communication network in response to a user request.

In another embodiment of the present disclosure, a non-transitory computer-readable storage medium embodying instructions that, when executed by a processing device, cause the processing device to perform a method of displaying author's annotations of an electronic book. The method comprises: (1) accessing content of the electronic book; (2) accessing an author's annotation associated with a first portion of the content; (3) rendering a first graphical user interface (GUI) for display, wherein the first GUI comprises: a content display area configured to display the content; a first visual object indicating presence of the author's annotation associated with the first portion; and rendering a second GUI for display upon receiving a user's interaction with the first visual object, wherein the second GUI is configured to display the author's annotation.

In another embodiment of the present disclosure, a system comprises: a processor; a communication circuit; and memory coupled to the processor and comprising instructions that, when executed by the processor, cause the system to perform an method of rendering content of a published electronic book with public annotations on a display device. The method comprises: (1) accessing content of the published electronic book; (2) rendering a first graphical user interface (GUI) on the display device, wherein the first GUI is configured to display the content of the published electronic book; (3) accessing a public annotation pertaining to the published electronic book, and wherein the public annotation is made public after publication of the electronic book, and wherein the first GUI is further configured to display the public annotation on the display device.

This summary contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 is a block diagram illustrating an exemplary system of electronically distributing public annotations of an electronic publication in accordance with an embodiment of the present disclosure.

FIG. 2 is a flow chart depicting an exemplary computer implemented method of supplying up-to-date annotations of an e-book through a network and using a graphical user interface in accordance with an embodiment of the present disclosure.

FIG. 3 is a flow chart depicting an exemplary computer implemented method of using a graphical user interface for displaying e-book content with public annotations in accordance with an embodiment of the present disclosure.

FIG. 4A illustrates an exemplary reading experience on-screen GUI including an avatar icon 403 indicating presence of an author's annotation and a generic icon indicating presence of reader-annotations in accordance with an embodiment of the present disclosure.

FIG. 4B illustrates an exemplary on-screen annotation display window configured to display an annotation dialog between an author and the reader community in accordance with an embodiment of the present disclosure.

FIG. 5 illustrates an exemplary on-screen annotation summary GUI that includes an aggregation of saved annotations of an e-book according to an embodiment of the present disclosure.

FIG. 6A is an exemplary library page including book covers that are labeled with an icon indicating availability of author's annotations of the represented books in accordance with an embodiment of the present disclosure.

FIG. 6B is an exemplary author's page that can include indicators of the presence of author's annotations of the author's books.

FIG. 6C is an exemplary book overview page that includes an icon indicating the presence of author's annotations in accordance with an embodiment of the present disclosure.

FIG. 6D is an exemplary greeting page of an e-book with statements indicating the presence of author's annotations in the book.

FIG. 7 illustrates an exemplary on-screen reading experience GUI configured to receive an annotation entry in accordance with an embodiment of the present disclosure.

FIG. 8 illustrates another exemplary on-screen reading experience GUI configured to receive an annotation entry in accordance with an embodiment of the present disclosure.

FIG. 9 is a block diagram illustrating an exemplary computing system including a reading experience program that can display book content and the associated public annotations in accordance with an embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclature:

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or client devices. When a component appears in several embodiments, the use of the same reference numeral signifies that the component is the same component as illustrated in the original embodiment.

### A User Interface for Presenting an E-Book Along With Public Annotations

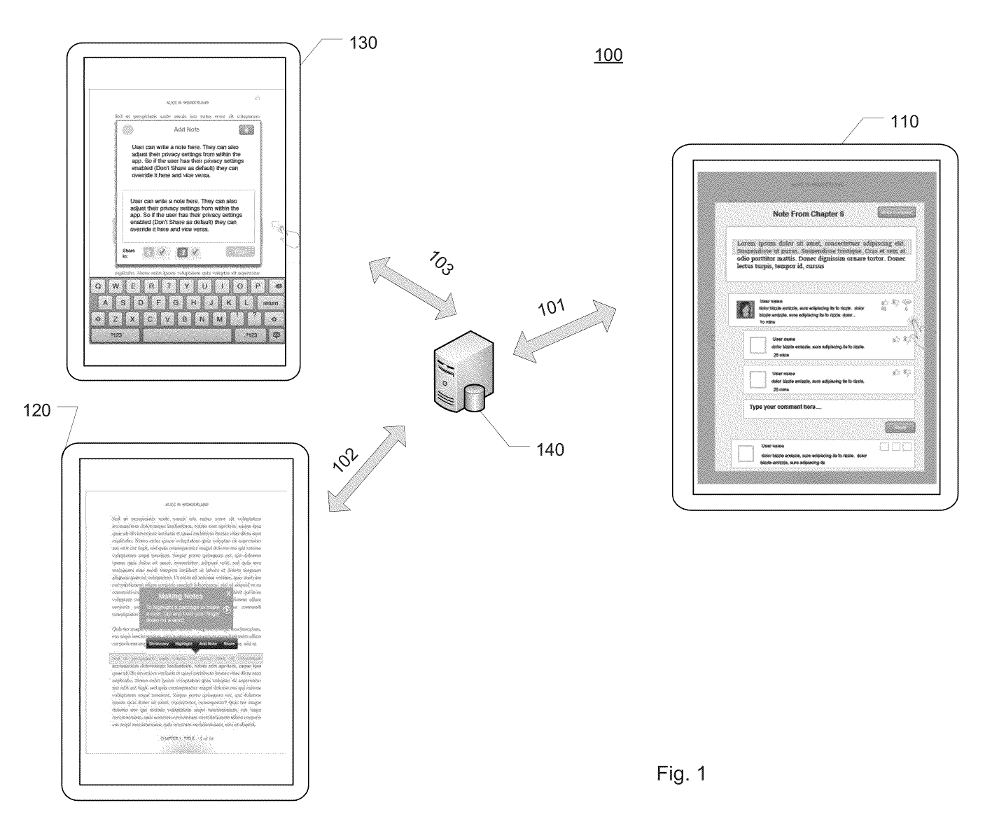

FIG. 1 is a block diagram illustrating an exemplary system 100 of electronically distributing public annotations of an electronic publication in accordance with an embodiment of the present disclosure. In this example, the system 100 includes a server device 140 coupled to electronic reading devices, e.g., 110, 120, and 130, through networks 101, 102 and 103. The electronic reading devices, e.g., 110, 120, and 130, have access to the content of the electronic publication, e.g., through purchase, download, or on-line access. An electronic reading device, e.g., 110, 120, or 130, installed with a reading experience program e.g., e-reader application, can render a graphical user interface (GUI) configured to display the e-book content as well as receive an annotation entry with respect to selected content of the electronic publication from a user and submit the entry to the server device 140 through the network. The server device 140 can then distribute the submitted annotation to subscriber electronic reading devices through networks which can render the annotation.

When the new annotation is received by an electronic reading device, a corresponding indication icon can be generated and presented in company with the selected content in a content display page. A user interaction with the icon can lead to display of the annotation content. Thereby, a reading experience program according to the present disclosure can advantageously provide an integrated platform for users to conveniently create and/or view public annotations of an electronic publication while contemporaneously viewing the content of the electronic publication.

The electronic publication referred herein may be any content capable of being read, for example an electronic book (e-book), an electronic newspaper (e-newspaper), an electronic magazine (e-magazine), or the like. The electronic publication may be initially downloaded to a reading device with or without annotations. It will be appreciated that the present disclosure is not limited to specific purposes and content of the annotations or comments. Publication can also be defined as publication through electronic channels and is not limited to print publication.

Available annotations of the electronic publication can be supplied to all the users who have acquired access to the electronic publication, e.g., through purchase or free download. Alternatively, the available annotations may be restricted to users who have subscribed to the service of updating the purchased e-books. In some embodiments, the annotations can be supplied to users as an updated version of the electronic publication.

In some embodiments, the annotation distribution service can be hosted by an on-line book store, the publisher of a collection of electronic publications, or a third-party social media network. In some embodiments, the server may include one server device. In some other embodiments, the server may include a plurality of server devices that are logically and/or physically distributed. Although FIG. 1 illustrates a network structured in a sever-client model, the distribution of public annotations according to the present disclosure can be implemented in any other suitable network structure, such as in accordance with a peer-to-peer model.

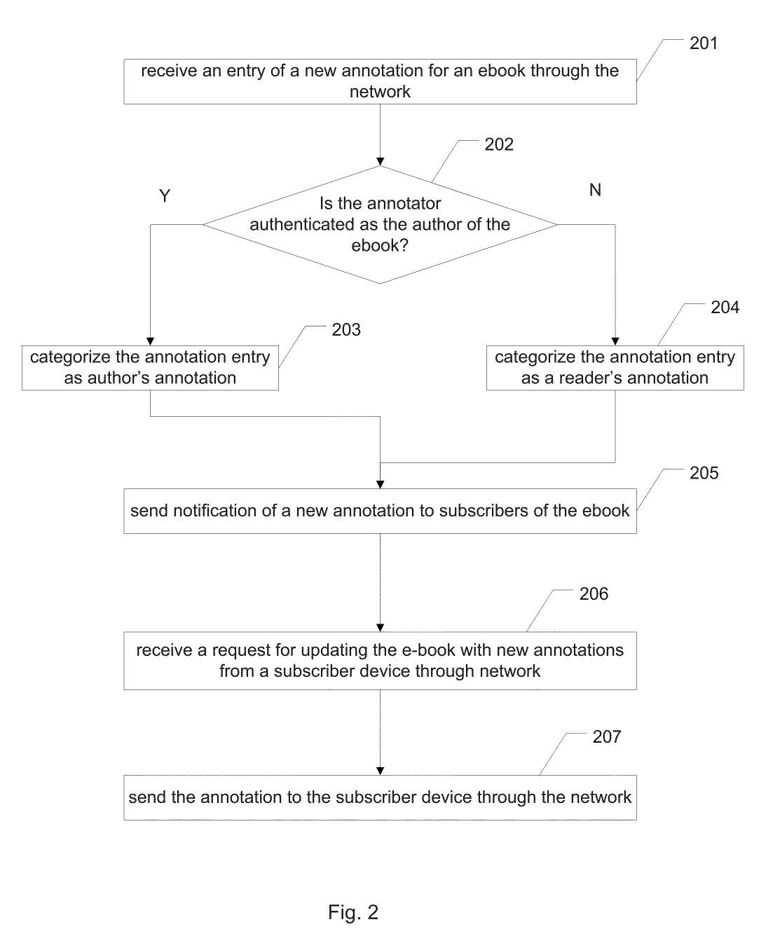

FIG. 2 is a flow chart depicting an exemplary computer implemented method 200 of supplying up-to-date annotations of an e-book through a communication network in accordance with an embodiment of the present disclosure. Method 200 can be implemented as an annotation updating service program on a server machine, e.g., 140 in FIG. 1. At 201, a new annotation entry with respect to an electronic book is submitted through the network and received.

Although the present disclosure is not limited to any specific class of annotators that can create annotations for an electronic publication, author's annotations are probably considered most interesting by many readers and likely attract more attention from average users. In some embodiments, the annotators can be identified, and so annotations by the author can be acknowledged and treated differently from other reader-annotators. Thus, at 202, it is determined whether a given annotator is the author of the e-book through an authentication process. Accordingly, the instant annotation entry being processed can be categorized as an author's annotation at 203, or as a reader's annotation at 204. In some embodiments, the special treatments for author's annotations can be extended to other invited annotators, such as an editor of the e-book and a publisher-invited commentator.

At 205, a notification indicating the availability of a new annotation is sent to the subscriber client devices. In some embodiments, such a notification may be generated and distributed each time a new annotation is submitted over the network. For instance, an in-page notification may appear briefly each time the author of a book in the user's library posts a new comment or another user responds to a thread to which the present user also contributed to. The in-page notification can be dismissed or alternatively trigger an on-screen popup window that displays that thread. The user may be allowed to configure the settings for the notification display. In some other embodiments, the notifications may be sent periodically. At 206, a request for updating the e-book with new annotations is received from a subscriber device. At 207, the content of the annotation is sent to the subscriber device through the network.

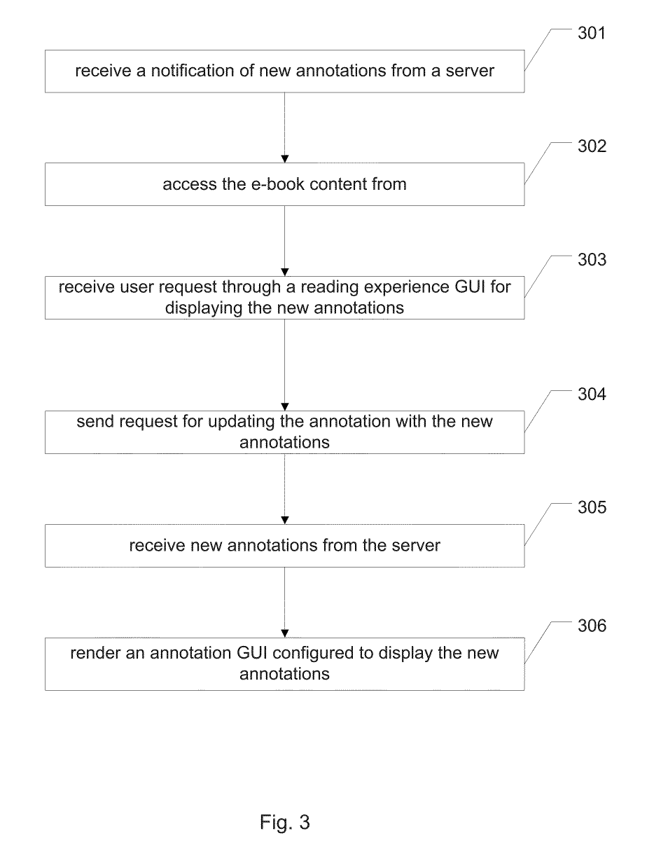

FIG. 3 is a flow chart depicting an exemplary computer implemented method 300 of displaying e-book content along with public annotations in accordance with an embodiment of the present disclosure. Method 300 can be implemented as a reading experience software program (“application”) installed on an electronic reading device. At 301, a notification of new annotations is received from the network. As described with above, the notification may be provided by a server. At 302, the content of the e-book is accessed from the local reading device or remotely from the server, and displayed on a reading experience GUI. At 303, a user request is received through the reading experience GUI for displaying the new annotations. At 304, the request for updating the annotations of the book is sent over the network to the server. In response, new annotations are supplied from the server through the communication network to the electronic reading device at 305. At 306, in response to a user request, an annotation GUI may be rendered to display selected annotations.

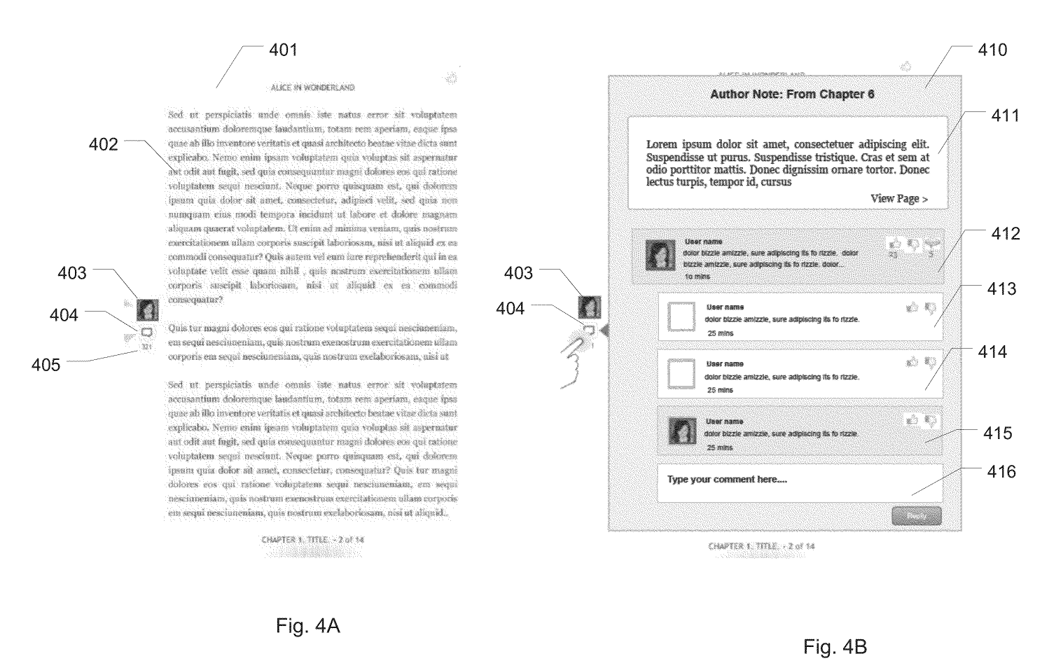

FIG. 4A illustrates an exemplary reading experience GUI 401 including an avatar icon 403 indicating presence of an author's annotation and a generic icon 404 indicating presence of reader-annotations in accordance with an embodiment of the present disclosure. The reading experience GUI 401 includes an onscreen book content display area 401 exemplary designed in the form of a book page. The two icons 402 and 404 are positioned in the left page margin and adjacent to the annotated book content which may be a paragraph, a sentence, a phrase, a term, a word, a symbol, and image, etc. In this example, the avatar icon 403 is an author's profile picture, but could be any indicia. In some embodiments, an icon of the author's annotation may be displayed with sufficient prominence, e.g., through color or highlighting.

The generic icon 404 is labeled with the number of reader annotations 405 associated with the instant annotated book content. The reader annotations may be in response to comments to the author's annotation or independent annotations. However, it will be appreciated by those skilled in the art that the present disclosure is not limited to any specific designs and configurations of annotation indicators used to indicate the presence and locations of the annotations.

When a user selects either of the two annotation icons, 403 or 404, several selected or all annotations can be displayed in a foreground representation window while the e-book content recedes into the background, e.g., in a grayed-out state. In some embodiments, a user interaction with the generic icon 404 leads to an on-screen display of a list of independent annotations pertaining to the selected book content. Once a user selects an independent annotation from the list, all the response annotations made in reply to the independent annotation can be displayed.

FIG. 4B illustrates an exemplary annotation display window 410 configured to display an on-screen annotation dialog between an author and the reader community in accordance with an embodiment of the present disclosure. In this example, the window 410 includes a region 411 to display the annotated e-book content and a series of dialog boxes to display the annotations, e.g., 412-415.

In this example, the author made an initial annotation 412 on the selected content 411. The response annotations, e.g., 413-415, are made in reply to the initial annotation. Thus, the group of annotations, e.g., 412-415 forms a running commentary or dialog between the author and the reader community of selected e-book content 411. The display window 410 also includes a text entry region 416 for a user to enter an annotation with respect to the selected e-book content 411 or in reply to one of the group of annotations, e.g., 412-415. A user can elect to post the annotation as a public annotation or save it as a private annotation.

As illustrated, each individual annotation, e.g., 412-415, is displayed in an on-screen boxed region which may also include the ID and on-line status of the annotator's, and any other related symbols, e.g., a like or dislike icon. A user may be allowed to configure the display format settings for the running dialog, for example using different colors for the display boxes so as to easily identify the user's own annotations or his or her friends' annotations.

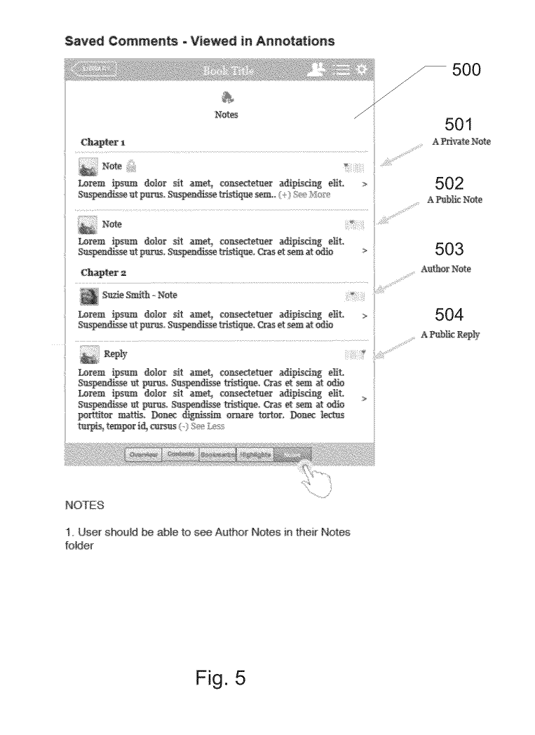

A user may be allowed to store selected or all annotations of the e-book to a local storage device or remote cloud storage, or both. The saved annotations may be arranged in a summary GUI as shown in FIG. 5. FIG. 5 illustrates an exemplary annotation summary GUI 500 that includes an aggregation of saved annotations of an e-book according to an embodiment of the present disclosure. The saved annotations 501-502 can be sorted by book chapters. Each saved annotation can be labeled with its associated category, e.g., private note, public note, author's note, and public reply.

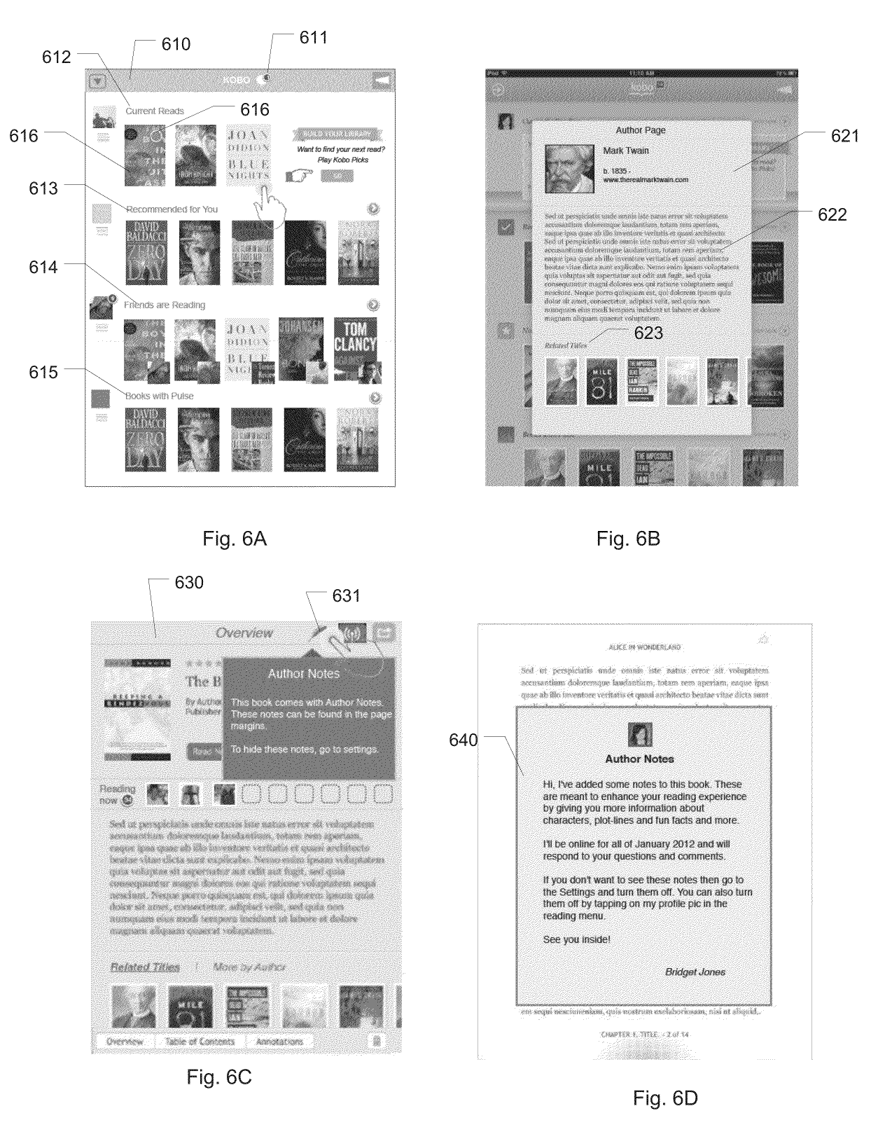

The presence of public annotations, especially author's annotations, can be indicated in other documents or GUIs related to the e-book. FIG. 6A is an exemplary library page 610 including book covers that are labeled with an icon indicating availability of author's annotations of the represented books in accordance with an embodiment of the present disclosure. For instance, the library page 610 may be associated with a user's book store account and include collections of the “current reads” 612, “recommended for you,” 613, “friends are reading,” 614 and “books with pulse” 615. Specifically, the book cover 616 is displayed with a dot icon 617 which may be defined to represent presence of author's annotations, or public annotations in general, of the book.

Additionally, the library page 610 also displays a notification label 611 that indicates the number of unread or new response annotations that are made in reply to the user's public annotations. A user interaction with the notification label 611 may prompt the display of a new annotation list. In response to a user's selection with a new annotation, the corresponding conversation thread can be expanded for display.

FIG. 6B is an exemplary author's page 621 that can include indicators of the presence of author's annotations of the author's books. The author's page 621 provides introductory information 622 of a book author and a collection of books 623 authored thereby. The book covers in the collection 623 may be labeled with indicators as described with reference to FIG. 6A.

FIG. 6C is an exemplary book overview page 630 that includes an icon 631 indicating the presence of author's annotations in accordance with an embodiment of the present disclosure. FIG. 6D is an exemplary greeting page 640 of an e-book with statements indicating the presence of author's annotations in the book.

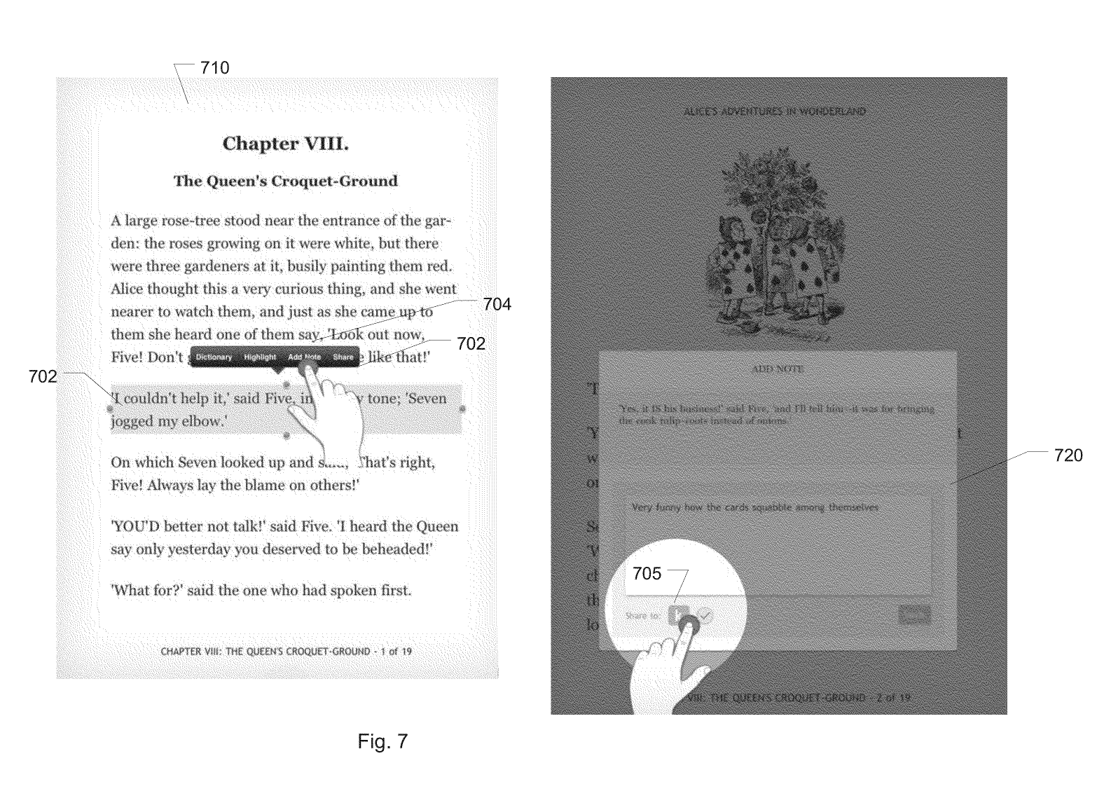

A public annotation according to the present disclosure can be entered through any suitable GUI configuration and design. FIG. 7 illustrates an exemplary reading experience GUI 710 configured to receive an annotation entry in accordance with an embodiment of the present disclosure. In response to a user's selection for the sentence 702, a menu 703 can be displayed and provides an “add note” option 704 to enter an annotation for the sentence 702. When the “add note” option 704 is selected, a text entry window 720 can be triggered to receive the user input. Then a user can choose to post the entered annotation as a public annotation by clicking the icon 705 or to keep it as a private annotation.

If an annotation is to be posted as an author's annotation, the user's identification will be authenticated, in one embodiment for instance based on the user's account ID and password. Upon authentication, the annotation can be acknowledged as an author's annotation and to be presented accordingly as described above.

In some embodiments, a user is provided with options to share a public annotation with an on-line book store, the publisher of the book, friends of a social media network, and/or to a reader community.

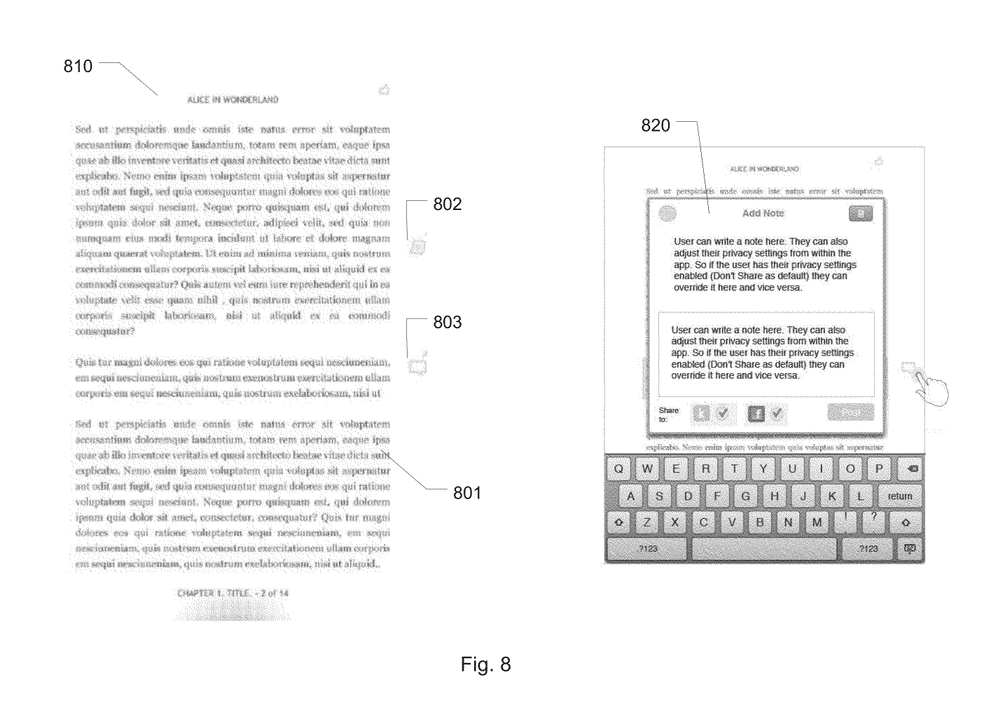

FIG. 8 illustrates another exemplary reading experience GUI 810 configured to receive an annotation entry in accordance with an embodiment of the present disclosure. The reading experience GUI 810 includes icons on-screen 802 and 803 rendered on the right margin of the reading page which denote private annotations and public annotations entered by the user respectively. Through the GUI 810, a user can highlight a text and select to add a note, which prompts the dialog window 820 configured to receive user input for a private or public annotation. The user may be allowed to adjust privacy settings with respect to his or her annotation entries. For instance, default settings are set to share all annotation entries. Once an annotation is made public, the user may be allowed to delete and/or edit the annotation.

In some embodiments, a user can override the default settings from a note dialog window, e.g., 820. If the user has set broadcasting through a social media network for the book to OFF, they will be prompted to turn the setting ON if they select the social media network. If a user makes a public annotation and it gets replies posted to it, then when the user taps on the note icon, the thread can be displayed. The user may delete his comment but may not be able to remove the entire thread. The user's comments may be colored differently from others.

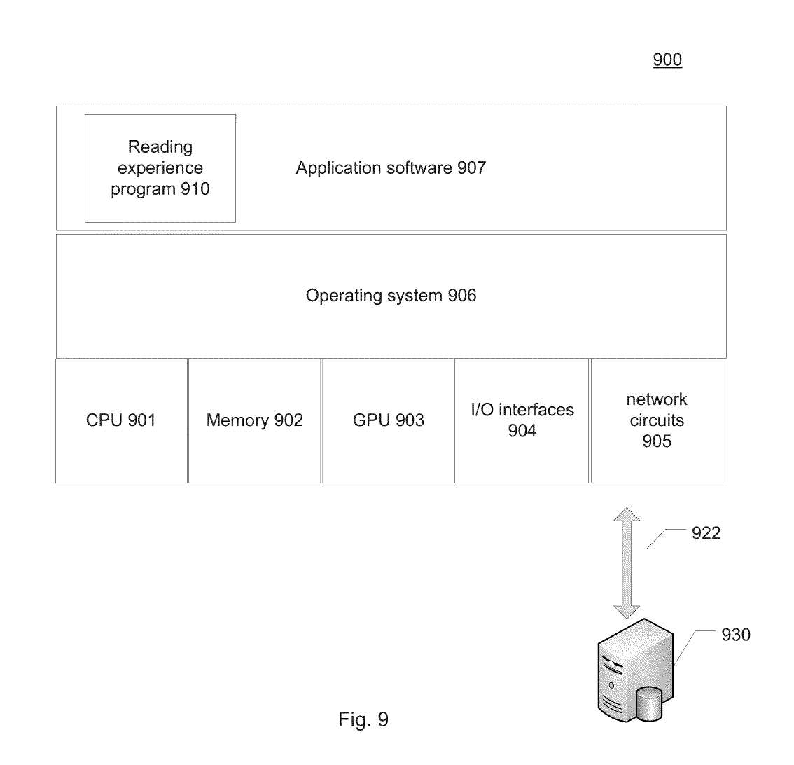

FIG. 9 is a block diagram illustrating an exemplary computing system 900 including a reading experience program 910 that can display book content and the associated public annotations in accordance with an embodiment of the present disclosure. The computing system 900 comprises a processor 901, system memory 902, a GPU 903, I/O interfaces 904, network circuits 905, an operating system 906 and application software 907 including the reading experience program 910 stored in the memory 902. In the illustrated example, the computing system 900 is coupled to a server 930 through a communication channel 922.

When incorporating configuration input and personalized input and executed by the CPU 901, the reading experience program 910 can present e-book contents as well as corresponding public and private annotations in accordance with an embodiment of the present disclosure. The reading experience program 910 may perform various other functions as discussed in details with reference to FIG. 1-FIG. 8. As will be appreciated by those with ordinary skill in the art, the reading experience program 910 can be implemented in any one or more suitable programming languages that are known to those skilled in the art, such as C, C++, Java, Python, Perl, C#, SQL, etc.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

1. A computer implemented method of displaying information related to published electronic book thereof on a display device, said computer implemented method comprising:
accessing content of said published electronic book;
rendering a first graphical user interface (GUI) on said display device, wherein said first GUI displays said content of said published electronic book;
accessing a public annotation, and wherein said public annotation is published after publication of said published electronic book; and
displaying said public annotation within said GUI.

2. The computer implemented method of claim 1 further comprising receiving a notification through a communication network indicating availability of public annotations of said published electronic book, wherein said first GUI is further configured to:
present an on-screen indicia indicative of said notification; and
receive a user request for displaying said public annotation on said display device.

3. The computer implemented method of claim 2 further comprising accessing a number of response annotations through said communication network responsive to a user interaction with said first GUI, wherein said first GUI is further configured to display said number of response annotations and said public annotation in a format resembling a conversation thread, in response to a user request.

4. The computer implemented method of claim 3,
wherein said public annotation is authored by an authorized annotator selected from a group consisting of an author of said electronic book, an editor of said electronic book, and a publisher-invited annotator of said electronic book, and
wherein said response annotations are authored by users having access to said electronic book.

5. The computer implemented method of claim 3, wherein said public annotation pertains to a selected portion of said content and is authored by an author of said published electronic book, and wherein said first GUI is further configured to:
render a first visual object proximate to said selected portion, wherein said first visual object is representative of said author's identification; and
render a second visual object proximate to said selected portion, wherein said second visual object is representative of public annotators generically.

6. The computer implemented method of claim 3, wherein said public annotation, said response annotations, and said notification are supplied from a remote server, wherein said remote server is hosted by one of an on-line book store, a publisher, and an online social networking service provider.

7. The computer implemented method of claim 5, wherein said first GUI is further configured to receive an annotation entry pertaining to said content through said display device, and further comprising submitting said annotation entry to said remote server through said communication network in response to a user request.

8. The computer implemented method of claim 1 further comprising rendering a second GUI in response to a user request, wherein said second GUI is configured to:
present summary information with respect to said published electronic book; and
present an on-screen indicia indicating availability of annotations of said published electronic book,
wherein said summary information comprises one of a cover page of said published electronic book, an author information page, an overview of said published electronic book, and a table of content of said published electronic book.

9. A non-transitory computer-readable storage medium embodying instructions that, when executed by a processing device, cause the processing device to perform a method of displaying author's annotations of an electronic book, said method comprising:
accessing content of said electronic book;
accessing an author's annotation associated with a first portion of said content;
rendering a first graphical user interface (GUI) for display, wherein said first GUI comprises:
a content display area configured to display said content;
a first visual object indicating presence of said author's annotation associated with said first portion;
rendering a second GUI for display upon receiving a user's interaction with said first visual object; and
displaying said author's annotation on said second GUI.

10. A non-transitory computer-readable storage medium of claim 9, wherein said author's annotation is provided through a communication network, and wherein said method further comprises:
storing said author's annotation responsive to a user's request; and
disabling said rendering said second GUI in response to a use request.

11. The non-transitory computer-readable storage medium of claim 9, wherein said method further comprises:
receiving a notification with respect to said author's annotation through a communication network before said accessing said author's annotation; and
presenting an on-screen indicia responsive to said receiving said notification.

12. The non-transitory computer-readable storage medium of claim 9,
wherein said method further comprises receiving reply annotations of said author's annotations through said communication network,
wherein said reply annotations are authored by users having access to said electronic book in reply to said author's annotation,
wherein said first GUI comprises a second visual object indicating presence of said reply annotations, and
wherein said second GUI is further configured to display said reply annotations in a conversation thread in response to a user interaction with said second visual object.

13. The non-transitory computer-readable storage medium of claim 9, wherein said first GUI is further configured to receive an annotation entry with respect to a second portion of said content, wherein said method further comprises associate an annotation category with said annotation entry in response to a user instruction, wherein said annotation category is one of a public annotation, a private annotation, and an author's annotation.

14. The non-transitory computer-readable storage medium of claim 13, wherein said first GUI is further configured to:
receive a user-ID and a password to identify an annotator of said annotation entry; and
associate an annotator category with said annotation entry,
wherein said annotator category is one of an author of said electronic book, a member of a social media network, and other readers of said electronic book.

15. The non-transitory computer-readable storage medium of claim 13, wherein said method further comprises sending a request through said communication network for removing said annotation entry from said publication with said electronic book in response to a user instruction.

16. The non-transitory computer-readable storage medium of claim 13, wherein said method further comprises rendering a second GUI for display, wherein said second GUI comprises:
a table of content of said electronic book; and
summary information with respect to annotations of said electronic book.

17. A system comprising:
a processor;
a communication circuit for communicating over a network channel; and
memory coupled to said processor and comprising instructions that, when executed by said processor, cause the system to perform an method of rendering content of a published electronic book with public annotations on a display device, said method comprising:
accessing content of said published electronic book;
rendering a first graphical user interface (GUI) on said display device, wherein said first GUI is configured to display said content of said published electronic book;
accessing a public annotation pertaining to said published electronic book, and wherein said public annotation is made public after publication of said electronic book, and
displaying said public annotation on said display device within said first GUI.

18. The computer implemented method of claim 17 further comprising:
receiving a notification through said network channel indicating availability of said public annotation before said accessing said public annotation;
receiving a notification through said network channel indicating availability of a number of response annotations pertaining to said public annotation;
accessing said number of response annotations through said network channel, and
wherein said first GUI is further configured to display said number of response annotations and said public annotation in a form of a conversation thread in response to a user request.

19. The computer implemented method of claim 18, wherein said public annotation, said response annotations, and said notification are supplied from a remote server, wherein said remote server is hosted by an on-line book store, a publisher, or a third-party service provider.

20. The computer implemented method of claim 19, wherein said first GUI is further configured to receive a user input of an annotation entry pertaining to said content through said display device, and further comprising submitting said annotation entry to said remote server through said network channel in response to a user request.
